(19) United States
(12) Patent Application Publication
(10) Pub. No.: US 2017/0043477 A1
(43) Pub. Date: Feb. 16, 2017

(54) ROBOT SYSTEM WITH VISUAL SENSOR AND A PLURALITY OF ROBOTS

(71) Applicant: FANUC CORPORATION, Yamanashi (JP)

(72) Inventors: Ayumu KITAYAMA, Yamanashi (JP); Takashi ITSUKAICHI, Yamanashi (JP)

(21) Appl. No.: 15/226,980

(22) Filed: Aug. 3, 2016

(30) Foreign Application Priority Data
Aug. 10, 2015 (JP) 2015-158363

(51) Int. Cl. B25J 9/00; B25J 9/16

(52) U.S. Cl. CPC B25J 9/0084; B25J 9/1697

(57) ABSTRACT

A robot system includes a first robot for operation to which a work tool is attached, a second robot for delivery to which a hand is attached, a first visual sensor attached to the first robot, a first control device for controlling the first robot, and a second control device for controlling the second robot. The first control device detects the position of a workpiece when an operation is performed based on the image captured by the first imaging device. The second control device includes a second correction unit for calculating the amount of correction in the second robot which relates to a deviation of the position of the workpiece relative to the hand, based on the position of the workpiece which is acquired from the first control device.

### BACKGROUND OF THE INVENTION

1. Field of the Invention

The present invention relates to a robot system provide with a plurality of robots.

2. Description of the Related Art

In, for example, factories for manufacturing products, a plurality of robots may perform one operation. Specifically, in some cases, while a robot for delivery grasps a workpiece, a robot for operation performs a predetermined operation for the workpiece. In this respect, the workpiece is supported by the robot for delivery, and accordingly, the accuracy of the operation reduces when the position of the workpiece deviates from a predetermined position. Thus, it is preferable that the position of the workpiece is accurately identified before the robot for operation performs an operation.

Japanese Unexamined Patent Publication No. 2012-61553A discloses a robot system which performs a sealing operation, etc., by detecting a workpiece using a visual sensor, and correcting the amount of deviation in the position of the delivered workpiece. This publication discloses that a first vision camera captures an image of a reference hole of a workpiece so as to roughly measure the position of the workpiece, and also discloses that a second vision camera captures an image of the reference hole of the workpiece so as to accurately measure the position of the workpiece.

The robot for delivery conveys an unprocessed workpiece to a position at which the workpiece is operated. After the robot for operation performs an operation for the workpiece, the robot for delivery conveys the workpiece to a predetermined position. For example, the robot for delivery places the processed workpiece to, for example, a predetermined jig. On this occasion, it is preferable that the robot for delivery dispose the workpiece in an accurate position in the jig.

However, when a hand attached to the robot for delivery grasps an unprocessed workpiece, it may grasp a portion which deviates from a desired portion. When, for example, the hand grasps a workpiece which has been conveyed by a conveyor or the like, the hand may grasp a position which deviates from a predetermined position. Thus, a workpiece may be grasped in the state in which there is a deviation in the position of the workpiece relative to the hand.

If there is a deviation in the position at which the hand grasps a workpiece, the processed workpiece may not be disposed accurately at a jig when the workpiece is conveyed to a predetermined position. In conventional technologies, in addition to a visual sensor for detecting a deviation in the position of a workpiece for an operation of the robot for operation, another visual sensor for detecting a deviation in a grasping operation of the hand is provided. Alternatively, it is necessary to provide a mechanism for guiding a workpiece to an accurate position in a jig to which a workpiece is to be disposed. Thus, in order to correct a deviation in a grasping operation of the hand, the complexity of the mechanism of the robot system increases.

### SUMMARY OF THE INVENTION

A robot system in the present invention is provided with a first robot for operation to which a work tool is attached, and a second robot for delivery to which a hand for grasping a workpiece is attached. The robot system is provided with a first imaging device for capturing an image of the workpiece which is attached to the first robot. The robot system is provided with a first control device for controlling the first robot, and a second control device for controlling the second robot. The first control device and the second control device are connected by a communication line, and can communicate with each other. The first control device includes a first image processing unit for detecting the position of the workpiece based on the image captured by the first imaging device. The first control device includes a first correction unit for calculating the amount of correction of the position and the posture of the first robot when the first robot performs an operation based on the detected position of the workpiece. The first control device includes a first motion control unit for driving the first robot based on the amount of correction calculated by the first correction unit. The second control device includes a second correction unit for calculating the amount of correction in the second robot, which relates to a deviation of the position of the workpiece relative to the hand based on the position of the workpiece, which is acquired from the first control device via the communication line. The second control device includes a second motion control unit for driving the second robot based on the amount of correction calculated by the second correction unit, when the processed workpiece is conveyed to a predetermined position.

In the above invention, the first control device and the second control device can be configured to control the positions and the postures of the first robot and the second robot in a coordinate system which is common to the first robot and the second robot. The second control device can acquire the position of the workpiece in the same coordinate system from the first control device.

In the above invention, the robot system can include a carrier member for receiving the processed workpiece from the second robot, and a second imaging device for capturing an image of the carrier member. The second control device can include a second image processing unit for detecting the position of the carrier member based on the image captured by the second imaging device. The second correction unit can calculate the amount of correction in the second robot, which relates to a deviation of the position of the carrier member, based on the detected position of the carrier member.

In the above invention, the first imaging device has a function of the second imaging device and the first motion control unit controls the position and the posture of the first robot so that the first imaging device can capture an image of the carrier member.

### BRIEF DESCRIPTION OF THE DRAWINGS

FIG. 1 is a schematic view of a robot system in an embodiment.

FIG. 2 is an enlarged perspective view of a workpiece when the workpiece is processed.

FIG. 3 is a block diagram of a robot system in an embodiment.

FIG. 4 is a flowchart of control of a robot system in an embodiment.

### DETAILED DESCRIPTION

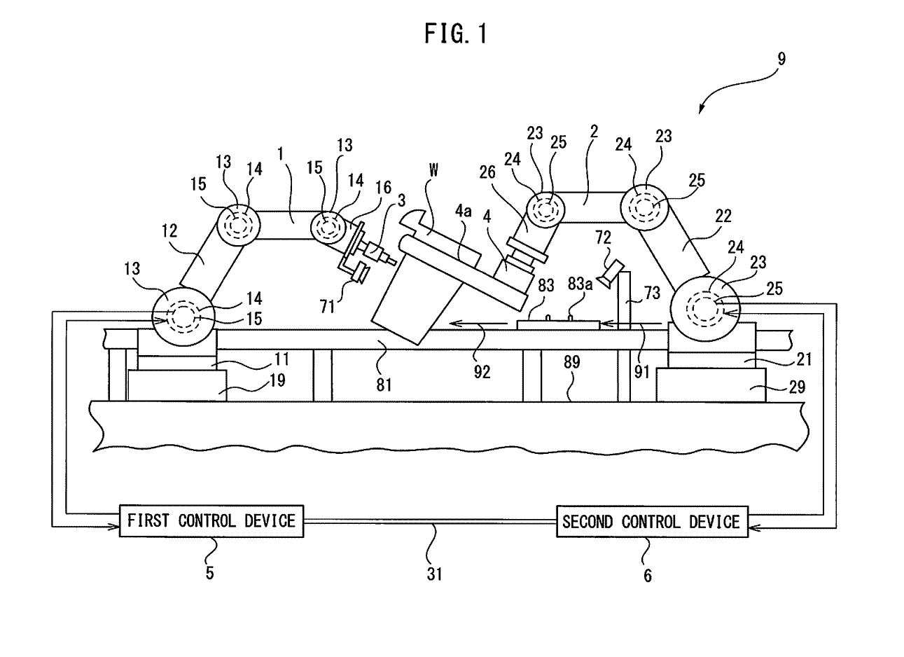

A robot system in an embodiment will be described with reference to FIGS. 1 to 4. The robot system in the present embodiment is provided with a plurality of robots. Some of robots convey a workpiece, and the other robots perform a predetermined operation for the workpiece.

FIG. 1 shows a schematic view of a robot system in the present embodiment. A robot system 9 in the present embodiment is provided with a first robot 1 and a second robot 2. The first robot 1 and the second robot 2 in the present embodiment are articulated robots. In the present embodiment, an operation for applying an adhesive agent to a predetermined position of a workpiece W will be described as an example.

The first robot 1 includes an arm 12, joint parts 13, and a wrist part 16. The first robot 1 includes an arm drive device for driving the joint parts 13. The arm drive device includes arm drive motors 14 disposed in the inside of the joint parts 13. The arm drive motors 14 are driven so that the direction of the arm 12 can be changed to a desired direction at the joint parts 13.

The first robot 1 includes a base part 19 secured to a mount surface 89, and a turn part 11 which can turn with respect to the base part 19. The turn part 11 is formed so as to rotate about a rotation axis perpendicular to the mount surface 89. The rotation of the turn part 11 causes the arm 12, the wrist part 16, and a work tool 3 to integrally rotate. The arm drive motors 14 include a motor for driving the turn part 11.

The first robot 1 includes a first state detector for detecting the position and the posture of the first robot. The position (the position of a tool tip point, etc.) of the robot and the posture of the robot are detected by the output of the state detector. The first state detector in the present embodiment includes rotation angle detectors 15 attached to the corresponding arm drive motors 14. The rotation angle detectors 15 detect the rotation angle of the arm drive motors 14 being driven. Based on the rotation angle of the arm drive motors 14, for example, the angle of the arm 12 at the joint parts 13 can be detected.

The work tool 3 serving as an end effector is attached to the first robot 1. The work tool 3 in the present embodiment is a gun for applying an adhesive agent to the workpiece W. The robot system 9 is provided with a work tool driving device for driving the work tool 3.

The second robot 2 in the present embodiment has a configuration similar to that of the first robot 1. The second robot 2 includes an arm 22, joint parts 23, and a wrist part 26. An arm drive device of the second robot 2 includes arm drive motors 24. The second robot 2 includes a base part 29 secured to the mount surface 89, and a turn part 21 which can turn with respect to the base part 29. Similar to the first robot 1, the second robot 2 includes a second state detector for detecting the position and the posture of the second robot 2. The second state detector includes rotation angle detectors 25 attached to the arm drive motors 24.

A hand 4 serving as an end effector is attached to the second robot 2. The hand 4 grasps or releases the workpiece W. In the hand 4 in the present embodiment, two claw parts 4a sandwich the workpiece W so as to grasp the workpiece W. The robot system 9 includes a hand drive device for driving the hand 4. The hand drive device in the present embodiment opens or closes the claw parts 4a of the hand 4.

The robot system 9 is provided with a first control device 5 for controlling the first robot 1 and a second control device 6 for controlling the second robot 2. The first robot 1 and the work tool 3 are driven based on motion commands of the first control device 5. The second robot 2 and the hand 4 are driven based on motion commands of the second control device 6. Further, the output of the first state detector is input to the first control device 5, and the output of the second state detector is input to the second control device 6. The robot system 9 is provided with a communication device for performing communication between the first control device 5 and the second control device 6. The first control device 5 and the second control device 6 are connected by a communication line 31, and can communicate with each other.

The robot system 9 in the present embodiment is provided with a transfer conveyor 81 as a carrier device for conveying the workpiece W. The transfer conveyor 81 can be controlled by the first control device 5 or the second control device 6. Alternatively, another control device for the transfer conveyor 81 may be separately provided, and the control device for the transfer conveyor 81 may be connected to the first control device 5 or the second control device 6 via the communication device.

The transfer conveyor 81 conveys, as designated by an arrow 91, an unprocessed workpiece W to a position at which the workpiece W can be grasped by the hand 4 attached to the second robot 2. Further, the transfer conveyor 81 discharges, as designated by an arrow 92, the processed workpiece W. The workpiece W is placed on a pallet 83 serving as a carrier member, and then, is conveyed. The pallet 83 in the present embodiment has positioning pins 83a for determining the position of the workpiece W on the pallet 83. The positioning pins 83a are fit in holes formed in the bottom face of the workpiece W.

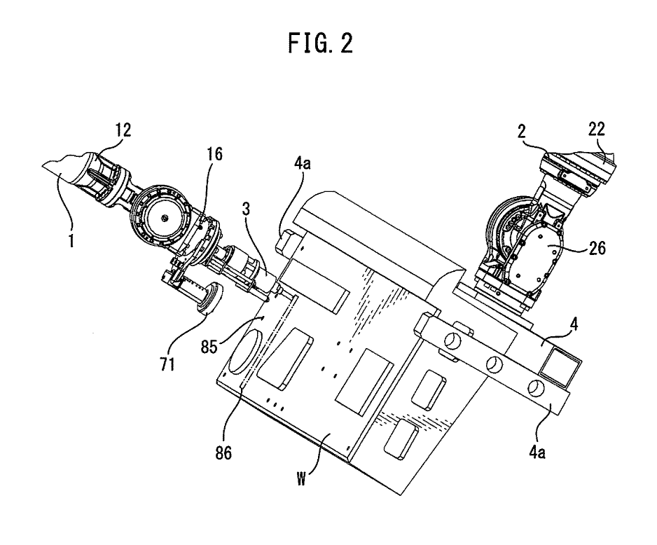

FIG. 2 shows an enlarged perspective view of a work tool, a hand, and a workpiece in the present embodiment. In the present embodiment, a motion program for the first robot 1 is preliminarily set. Further, a motion program for the second robot 2 is preliminarily set. The positions and the postures of the first robot 1 and the second robot 2 are changed based on the motion programs. Further, the work tool 3 and the hand 4 are driven based on motion programs.

In the present embodiment, while the workpiece W is grasped by the hand 4, the work tool 3 attached to the first robot 1 performs an operation. Namely, while the state of the workpiece W being supported by the second robot 2 is maintained, the work tool 3 applies an adhesive agent. In this example, the work tool 3 performs an operation for applying an adhesive agent to a linear area 86.

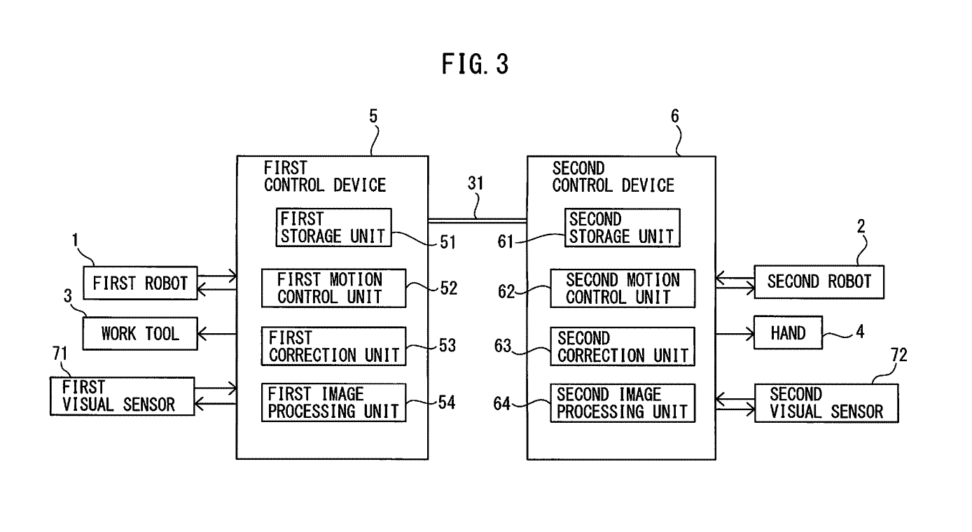

FIG. 3 shows a block diagram of a robot system in the present embodiment. The control devices in the present embodiment are comprised of arithmetic processing devices each having, for example, a central processing unit (CPU), a random access memory (RAM), and a read only memory (ROM), which are connected to one another via a bus line.

The first control device 5 includes a first storage unit 51 for storing, for example, motion programs regarding the motion of the first robot 1 and the work tool 3. The first control device 5 includes a first motion control unit 52 for controlling the motion of the first robot 1 and the work tool 3. The first motion control unit 52 drives the first robot 1 and the work tool 3 based on the motion programs.

Similar to the first control device 5, the second control device 6 includes a second storage unit 61 and a second motion control unit 62. The second storage unit 61 stores motion programs regarding the motion of the second robot 2 and the hand 4. Further, the second motion control unit 62 drives the second robot 2 and the hand 4 based on the motion programs.

With reference to FIGS. 1 to 3, the robot system 9 in the present embodiment is provided with a first visual sensor 71 as a first imaging device attached to the first robot 1. The first visual sensor 71 captures an image of the workpiece W. Examples of the first visual sensor 71 include any sensors which can detect the position of the workpiece W from the captured image. For example, a three dimensional visual sensor can be adopted as the first visual sensor 71.

The transfer conveyor 81 introduces an unprocessed workpiece W to a predetermined position. The second motion control unit 62 drives the second robot 2 and the hand 4 based on the motion programs. The workpiece W is grasped by the hand 4. The second motion control unit 62 drives the second robot 2 so as to convey the workpiece W to a position at which the work tool 3 performs an operation. In the present embodiment, the position of the workpiece W, at which the workpiece W is processed, is referred to as a “work position”. FIG. 2 shows the state of the workpiece W being conveyed to the work position.

When the hand 4 attached to the second robot 2 grasps the workpiece W, the hand 4 may grasp the portion of the workpiece W, which deviates from a desired portion, due to a deviation in the position of the workpiece W. Thus, when the workpiece W is disposed at the work position, the workpiece W may deviate from a predetermined work position. The first control device 5 corrects this deviation in the position of the workpiece W, and then, performs an operation.

In the control devices in the present embodiment, the reference position and the reference posture of a robot when the imaging device captures an image of an object to be imaged are preliminarily set. Further, the storage unit of each control device preliminarily stores a reference image which is a criterion and which is captured at the reference position and the reference posture. Each reference image is an image captured when there are no errors in the position of a predetermined member and the position and the posture of the robot. Further, the control device corrects the position and the posture of the robot based on the image captured by the imaging device and the reference image.

The first control device 5 drives the first robot 1 based on the motion program, so that the first visual sensor 71 is located at a position opposed to the workpiece W located at the work position. Then, the first visual sensor 71 captures an image of the workpiece W. The positions and the postures of the first robot 1 and the position and the posture of the second robot 2 at the time of capturing an image of the workpiece W are determined by their respective motion programs. Namely, the work position of the workpiece W and the position of the first visual sensor 71 for capturing an image of the workpiece W are preliminarily determined.

The first control device 5 is provided with a first image processing unit 54 for processing an image captured by the first visual sensor 71. The first image processing unit 54 detects the position of the workpiece W based on an image captured by the first visual sensor 71.

The first storage unit 51 stores a reference image obtained by capturing an image of the workpiece W when the workpiece W is located at a desired position. Further, the first image processing unit 54 acquires the position of the workpiece W based on the captured image and the reference image. For example, the first image processing unit 54 detects the position of holes 85 formed in the back face of the workpiece W. The first image processing unit 54 calculates the amount of deviation of the position of the holes 85 in the image captured by the first visual sensor 71 relative to the position of the holes 85 in the reference image. The first image processing unit 54 can calculate the position of the workpiece W based on this amount of deviation.

The first control device 5 is provided with a first correction unit 53 for calculating the amount of correction of the position and the posture of the first robot 1 when the work tool 3 performs an operation. The amount of deviation of the position of the workpiece W corresponds to the amount of correction of the position and the posture of the first robot 1 being driven. The first correction unit 53 calculates the amount of correction when the first robot is driven, based on the position of the workpiece W which has been acquired by the first image processing unit 54. Further, during a processing operation for the workpiece W, the first motion control unit 52 drives the first robot 1 while correcting the position and the posture of the first robot 1 based on the amount of correction calculated by the first correction unit 53.

Thus, the control operation for correcting a deviation in the position of the workpiece W when the workpiece W is located at the work position enables the processing of the workpiece W at an accurate position. In the present embodiment, an adhesive agent can be applied to a desired position.

After an operation of the work tool 3, the second robot 2 conveys the workpiece W to the pallet 83 in order to discharge the workpiece W. As described above, when the hand 4 grasps an unprocessed workpiece W, the position of the workpiece W in the hand 4 may deviate from a desired position. In this respect, even when the second robot 2 conveys the workpiece W to the pallet 83 in accordance with the motion program, a deviation may arise in the position of the workpiece W relative to the pallet 83.

For example, in the present embodiment, the positioning pins 83a of the pallet 83 are fit in the holes formed in the bottom face of the workpiece W. However, if there is a deviation of the position of the workpiece W relative to the hand 4, even when the position and the posture of the second robot 2 is controlled based on the motion program, the positioning pins 83a may not be inserted to the holes of the workpiece W. Namely, an operation for disposing the workpiece W to the pallet 83 may fail.

With reference to FIG. 3, the second control device 6 in the present embodiment includes a second correction unit 63 for calculating the amount of correction when the second robot 2 is driven. The second correction unit 63 acquires the position of the workpiece W located at the work position from the first control device 5 via the communication line 31. The second correction unit 63 calculates the amount of deviation of the position of the workpiece W relative to the hand 4 based on the position of the workpiece W. The second correction unit 63 calculates, based on this amount of deviation, the amount of correction of the position and the posture of the second robot 2 when the workpiece W is conveyed to the pallet 83. In the present embodiment, the amount of deviation of the position of the workpiece W at the work position corresponds to the amount of deviation of the workpiece W relative to the hand 4 when the hand 4 grasps the workpiece W.

The second motion control unit 62 drives the second robot 2 while correcting the position and the posture of the second robot 2 based on the amount of correction calculated by the second correction unit 63. The second control device 6 drives the second robot 2 so that the deviation of the position of the workpiece W in the hand 4 is corrected. Namely, the second motion control unit 62 controls the second robot 2 so that the deviation of the position of the workpiece W relative to the hand 4 is cancelled.

This control enables the second robot to convey the processed workpiece W to a desired position. Further, in the present embodiment, a deviation of the workpiece W when the hand 4 grasps the workpiece W is acquired from the output of the first visual sensor 71, and accordingly, even when a visual sensor for correcting a deviation in the grasp of the workpiece W is not attached to the second robot 2, a deviation in the grasp of the workpiece W can be corrected. Alternatively, even when, for example, a guide plate for guiding the workpiece W to a desired position in the pallet 83 is not provided, the workpiece W can be located at a desired position in the pallet 83. Thus, the robot system in the present embodiment can correct, using a simple structure, a deviation in a grasping operation of the hand attached to the robot for delivery.

In the present embodiment, the same coordinate system is used as the coordinate system in which the first control device 5 controls the first robot, and the coordinate system in which the second control device 6 controls the second robot 2. Namely, the first control device 5 and the second control device 6 control the positions and the postures of the first robot 1 and the second robot 2 in the same coordinate system common to the first robot 1 and the second robot 2.

The common coordinate system can include a coordinate system in which the origin is stationary even when the first robot 1 and the second robot 2 are driven. For example, a coordinate system in which a predetermined point on the mount surface 89 is set as the origin can be adopted. The position and the posture of the first robot 1 and the position and the posture of the second robot 2 can be expressed in the common coordinate system. Further, the position of the work tool 3 and the position of the hand 4 can be expressed in the same coordinate system.

The second control device 6 in the present embodiment acquires, using the common coordinate system, the position of the workpiece W from the first control device 5. On this occasion, conversion of the coordinate system is not necessary, and accordingly, the second correction unit 63 of the second control device 6 can easily calculate the amount of correction. For example, the first control device 5 can control the first robot 1 in a first base coordinate system in which a predetermined point in the base part 19 of the first robot 1 is set as the origin. Further, the second control device 6 can control the second robot 2 in a second base coordinate system in which a predetermined point in the base part 29 of the second robot 2 is set as the origin. In this respect, conversion of a coordinate value from the first base coordinate system to the second base coordinate system is necessary. In contrast, in the present embodiment, the common coordinate system is used, and accordingly, the conversion of a coordinate value is not necessary, and processing in the control devices can be easily performed.

In the meantime, with reference to FIGS. 1 and 3, the pallet 83 in the present embodiment functions as a carrier member which receives the processed workpiece W from the second robot 2. The pallet 83 in the present embodiment is conveyed by the transfer conveyor 81. The position of the pallet 83 when the hand 4 grasps the workpiece W may deviate from a desired position. Thus, the pallet 83 may deviate from a predetermined position for receiving the workpiece W. In the robot system 9 in the present embodiment, a control operation for correcting a deviation of the position of the pallet 83 is performed.

The robot system 9 in the present embodiment is provided with a second visual sensor 72 serving as a second imaging device for capturing an image of the pallet 83. Similar to the first visual sensor 71, as the second visual sensor 72, any sensor which can detect the position of a member to be imaged can be used. The second visual sensor 72 is supported by a pedestal 73. In the transfer conveyor 81, the pallet 83 is located at a position at which the second robot 2 receives or delivers the workpiece W. The second visual sensor 72 captures an image of the pallet 83 while the pallet 83 is located at a predetermined position. In the present embodiment, the second visual sensor 72 captures an image of the pallet 83 after the second robot 2 conveys the workpiece W to the work position.

The second control device 6 includes a second image processing unit 64 for detecting the position of the pallet 83 based on the image captured by the second visual sensor 72. The second image processing unit 64 in the present embodiment acquires the position of the pallet 83 based on the position of the positioning pins 83a formed in the pallet 83. The second storage unit 61 preliminarily stores the reference image of the pallet 83 as a criterion. The reference image is an image of the pallet 83, which is captured when the pallet 83 is located at a desired position. The second image processing unit 64 calculates the position of the pallet 83 based on the captured image and the reference image.

The second correction unit 63 of the second control device 6 calculates the amount of deviation of the pallet 83 relative to a predetermined conveyance position based on the position of the pallet 83, which is detected by the second image processing unit 64. The amount of deviation of the position of the pallet 83 corresponds to the amount of deviation of the position and the posture of the second robot 2 when the workpiece W is conveyed to the pallet 83. The second correction unit 63 calculates the amount of deviation in the second robot 2 when the workpiece W is conveyed to the pallet 83.

The second correction unit 63 in the present embodiment calculates the amount of correction of the position and the posture of the second robot 2 based on the position of the workpiece W relative to the hand 4 which is detected from the image captured by the first visual sensor 71, and the position of the pallet 83 which is detected from the image captured by the second visual sensor 72. Further, the second motion control unit 62 drives the second robot 2 while correcting the position and the posture of the second robot 2 based on this amount of correction. This control enables the correction of deviation of the position of the pallet 83 and the placement of the processed workpiece W on the pallet 83. The second robot 2 enables the placement of the workpiece W at an accurate position in the pallet 83. Note that, a control operation for correcting a deviation of the conveyance position of the pallet 83 is performed in the present embodiment, but the control may not be performed in some embodiments.

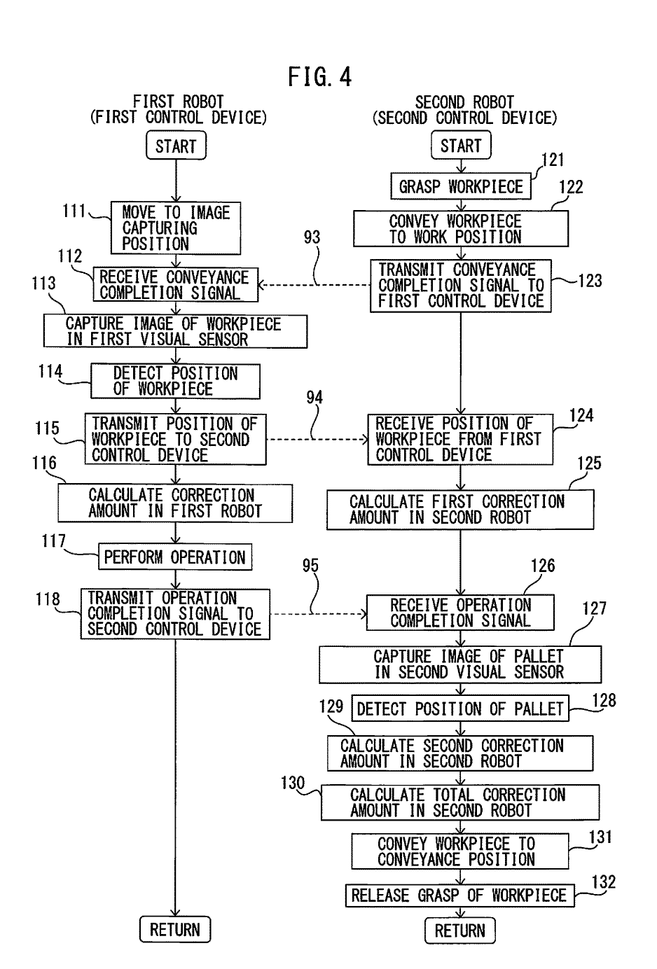

FIG. 4 is a flowchart of control of a robot system in the present embodiment. With reference to FIGS. 1, 3, and 4, the transfer conveyor 81 introduces an unprocessed workpiece W to a predetermined conveyance position. In step 121, the second control device 6 controls the second robot 2 to change the position and the posture of the second robot 2 so that the hand 4 can grasp the workpiece W. Then, the hand 4 grasps the workpiece 4.

Subsequently, in step 122, the second robot 2 conveys the workpiece W to a predetermined work position. In step 123, the second control device 6 transmits, as designated by an arrow 93, a signal representing that the conveyance of the workpiece W to the work position is complete to the first control device 5.

On the other hand, the first control device 5 drives, in step 111, the first robot 1 so that the first visual sensor 71 is located at a position for capturing an image. In step 112, a signal representing that the conveyance of the workpiece W is complete is received from the second control device 6.

Subsequently, the first control device 5 causes the first visual sensor 71 to capture an image of the workpiece W in step 113. In step 114, the first image processing unit 54 processes the image captured by the first visual sensor 71 so as to detect the position of the workpiece W.

Subsequently, in step 115, the first control device 5 transmits, as designated by an arrow 94, the position of the workpiece W which has been detected by the first image processing unit 54 to the second control device 6.

Subsequently, in step 116, the first correction unit 53 calculates the amount of correction when the first robot 1 and the hand 4 are driven based on the detected position of the workpiece W. Specifically, the first correction unit 53 calculates the amount of correction to correct a deviation of the position and the posture of the first robot 1. Further, in step 117, the first robot 1 and the work tool 3 are driven to process the workpiece W. On this occasion, the first motion control unit 52 drives the first robot 1 and the work tool 3 while correcting the position and the posture of the first robot 1.

After the processing of the workpiece W is complete, the first control device 5 transmits, in step 118, as designated by an arrow 95, a signal representing that the processing is complete to the second control device 6.

The second control device 6 receives, in step 124, the position of the workpiece W which has been detected by the first control device 5 from the first control device 5. In step 125, the second correction unit 63 calculates a first correction amount in the second robot 2 to correct a deviation of the relative position of the workpiece W relative to the hand 4 based on the position of the workpiece W. The first correction amount is the amount of correction to correct a deviation of the position and the posture of the second robot 2 with respect to an error arising when the hand 4 grasps the workpiece W. In step 126, the second control device 6 receives a signal representing that the processing is complete from the first control device 5.

Subsequently, in step 127, the second control device 6 causes the second visual sensor 72 to capture an image of the pallet 83. In step 128, the second image processing unit 64 detects the position of the pallet 83.

In step 129, the second correction unit 63 calculates a second correction amount in the second robot 2 when the processed workpiece W is conveyed to the pallet 83, based on the position of the pallet 83 which has been detected by the second image processing unit 64. The second correction amount is the amount of correction regarding a deviation of the position of the pallet 83 when the pallet 83 is introduced by the transfer conveyor 81. In step 130, the second correction unit 63 calculates the total amount of correction to correct a deviation of the position and the posture of the second robot 2, by adding the first correction amount and the second correction amount.

In step 131, the second motion control unit 62 conveys the workpiece W to the pallet 83 while correcting the position and the posture of the second robot 2, based on the total amount of correction calculated by the second correction unit 63. The conveyance of the workpiece W to the corrected position causes the positioning pins 83a of the pallet 83 to fit in the holes of the workpiece W. The robot system 9 in the present embodiment can convey the processed workpiece W to an accurate position in the pallet 83.

After the workpiece W is placed on the pallet 83, in step 132, the hand 4 releases the workpiece W. After that, the transfer conveyor 81 can discharge the processed workpiece W.

In the present embodiment, in order to detect a deviation of the position of the pallet 83, the second visual sensor 72 is disposed as a second imaging device. The second imaging device for capturing an image of a carrier member is not limited to this mode, and, for example, may be constituted by the first imaging device. Namely, the robot system 9 may be, for example, formed so that the first visual sensor 71 attached to the first robot 1 captures an image of the pallet 83.

In this respect, the first motion control unit 52 controls the position and the posture of the first robot 1 so that the first visual sensor 71 can capture an image of the pallet 83 after the processing of the workpiece W is complete. Further, the first control device 5 causes the first visual sensor 71 to capture an image of the pallet 83. The detection of the position of the pallet 83 based on the captured image of the pallet 83 can be performed by the first image processing unit 54 of the first control device 5. Alternatively, the captured image may be transmitted to the second image processing unit 64 of the second control device 6 so as to cause the second image processing unit 64 to detect the position of the pallet 83.

Thus, the robot system is formed so that the first visual sensor 71 can capture an image of the pallet 83, and accordingly, the first visual sensor 71 can capture an image which could have originally been captured by the second visual sensor 72. Thus, the necessity of disposing the second visual sensor 72 can be eliminated, and the configuration of the robot system can be simplified.

In the present embodiment, a gun for applying an adhesive agent is adopted as a work tool attached to the robot for operation. However, the work tool is not limited to this type, and any work tool can be adopted depending on the type of working. For example, any end effectors such as a work tool for welding, a work tool for spraying paint for paint application, etc. can be adopted.

Further, in the present embodiment, the transfer conveyor conveys a workpiece. However, the form is not limited to this, and any mode can be adopted for the start position at which a robot starts conveying an unprocessed workpiece and the position to which the processed workpiece is conveyed. Specifically, the present invention can be applied to any robot system in which a robot for delivery conveys the processed workpiece to a predetermined position.

In the present embodiment, robots are connected to control devices in a one-to-one basis. However, the form is not limited to this. For example, a plurality of robots may be controlled by a single control device. Further, the robot system in the present embodiment is provided with two robots. However, this is not the only mode, and, for example, three or more robots may be provided.

The present invention can provide a robot system with a simple structure, which can correct a deviation in a grasping operation of a hand attached to a robot for delivery.

In the respective controls above, the order of steps can be appropriately changed unless the function and operation are not changed. The above embodiments can be appropriately combined. Further, in the above drawings, the same or corresponding portions are designated with the same reference numerals. Note that the above embodiments are examples, and do not limit the invention. Further, the embodiments include modifications of aspects described in the claims.

1. A robot system comprising:
a first robot for operation, to which a work tool is attached;
a second robot for delivery, to which a hand for grasping a workpiece is attached;
a first imaging device for capturing an image of the workpiece, which is attached to the first robot;
a first control device for controlling the first robot; and
a second control device for controlling the second robot, wherein
the first control device and the second control device are connected by a communication line and can communicate with each other,
the first control device includes a first image processing unit for detecting a position of the workpiece based on the image captured by the first imaging device, a first correction unit for calculating an amount of correction of a position and a posture of the first robot when the first robot performs the operation based on a detected position of the workpiece, and a first motion control unit for driving the first robot based on the amount of correction calculated by the first correction unit, and
the second control device includes a second correction unit for calculating an amount of correction in the second robot, which relates to a deviation of a position of the workpiece relative to the hand, based on the position of the workpiece, which is acquired from the first control device via the communication line, and a second motion control unit for driving the second robot based on the amount of correction calculated by the second correction unit when the processed workpiece is conveyed to a predetermined position.

2. The robot system according to claim 1, wherein
the first control device and the second control device are configured to control positions and postures of the first robot and the second robot in a coordinate system which is common to the first robot and the second robot, and
the second control device acquires the position of the workpiece in the same coordinate system from the first control device.

3. The robot system according to claim 1, comprising:
a carrier member for receiving the processed workpiece from the second robot; and
a second imaging device for capturing an image of the carrier member, wherein
the second control device includes a second image processing unit for detecting the position of the carrier member based on the image captured by the second imaging device, and
the second correction unit calculates the amount of correction in the second robot, which relates to a deviation of a position of the carrier member, based on a detected position of the carrier member.

4. The robot system according to claim 3, wherein
the second imaging device is constituted by the first imaging device, and
the first motion control unit controls the position and the posture of the first robot so that the first imaging device can capture an image of the carrier member.
